(19) United States
(12) Patent Application Publication
(10) Pub. No.: US 2020/0104882 A1
(43) Pub. Date: Apr. 2, 2020

(54) TARGETED ADVERTISING SYSTEMS AND METHODS

(71) Applicant: Sphere Access, Inc., Tampa, FL (US)

(72) Inventor: Adam Allison, Denver, CO (US)

(21) Appl. No.: 16/585,398

(22) Filed: Sep. 27, 2019

Related U.S. Application Data
(60) Provisional application No. 62/739,691, filed on Oct. 1, 2018.

(51) Int. Cl. G06Q 30/02

(52) U.S. Cl. CPC G06Q 30/0269; G06Q 30/0243

(57) ABSTRACT

A system for and methods of providing targeted advertising and measuring effectiveness of the same is provided. The system includes a plurality of display devices associated with respective image capturing devices. The system is configured to determine a composite classification for groups of individuals engaged with or otherwise facing a display device, thereby assisting the system in identifying content to be displayed. Content is stored remotely and is categorized based on perceived effectiveness based on a number of factors, including location, time, demographics, and the like. While content is being displayed, the system is configured to assess a variety of actions, including attachment, dwell, rejection, and/or reattachment, as applicable, thereby assessing effectiveness of the content. Effectiveness of content is recorded for future reporting and/or for updating content categorization, thereby increasing reliability of identifying content in the future.

### CROSS-REFERENCE TO RELATED APPLICATIONS

This application claims priority pursuant to 35 U.S.C. 119(e) to co-pending U.S. Provisional Patent Application Ser. No. 62/739,691, filed Oct. 1, 2018, the entire disclosure of which is incorporated herein by reference.

### FIELD OF THE INVENTION

The present invention relates generally to advertisement delivery and tracking. More specifically, the present invention is concerned with intelligent systems and methods of targeting advertisements and improving how advertisements are targeted.

### BACKGROUND

Success or failure of a marketing campaign largely relies on getting the marketing materials in front of an intended audience, attracting the audience's attention, and maintaining the audience's attention. Unfortunately, not all marketing materials are effective for all audiences. Consequently, it would be beneficial to have a system for and methods of identifying a potential audience and for predicting effectiveness of marketing materials prior to displaying marketing materials to the audience. It would also be beneficial to ascertain the effectiveness of the marketing materials, such as by determining whether the marketing materials attracted and maintained the audience's attention.

Using traditional methods, it can take weeks or months to determine the effectiveness of a marketing campaign. Furthermore, traditional methods of measuring effectiveness of specific marketing materials, such as with focus groups, can be expensive, time-consuming, and misleading. For instance, effectiveness in a controlled environment may not accurately reflect effectiveness in the real world, especially if subjects are aware of, or suspicious that, their reaction to the marketing materials is being monitored. Furthermore still, replicating real-world environments can be difficult, expensive, and time-consuming. Consequently, it would be beneficial to have a system for and methods of obtaining real-world feedback for ascertaining the effectiveness of marketing materials. It would further be beneficial if the real-world feedback could be obtained discreetly, thereby increasing the reliability of the feedback. It would still further be beneficial if the real-world feedback could be obtained quickly, easily, and with minimal expense.

Some recent systems attempt to address at least some of the inherent issues with traditional marketing systems and methods. For instance, U.S. Patent Publication No. 2013/0005443 by Kosta et al. teaches systems and methods of displaying targeted content based on perceived demographic information. Unfortunately, the '443 Publication merely describes high-level concepts, requiring extensive experimentation to implement such concepts. Furthermore, known systems for implementing such high-level concepts are inefficient and also generally ineffective. Furthermore still, the '443 Publication fails to address systems for or methods of ascertaining effectiveness of marketing materials and/or for ascertaining the effectiveness of systems and/or methods of delivering the marketing materials. Consequently, it would be beneficial to have a system for and methods of effectively and efficiently implementing the high-level concepts mentioned in the '443 Publication. Furthermore, it would be beneficial to have a system for and methods of ascertaining the effectiveness of such systems and methods and/or marketing materials associated with such systems and methods.

Furthermore, the '443 Publication fails to indicate how data is provided to a user, if at all, and/or whether data is applicable to the user and/or to the generality of singular users. Furthermore, the '443 Publication fails to address potential issues with such systems, such as whether there is a risk of a 1 to 1 relationship with data to a user and/or how to avoid such potentially illegal functions. Furthermore still, the '443 Publication fails to provide any metric of effectiveness. Consequently, it would be beneficial to have a system for and methods of avoiding potential issues while establishing measurable effectiveness. For instance, it would be beneficial to have a system for and methods of determining a ratio of attract to dwell and/or dismiss in concert with demographic and segmentation, thereby providing a clear indication of effectiveness.

Furthermore still, prior art systems utilize open source tools having no correlation with, or understanding of why or how, such tools obtain results. For example simply using a facial recognition tool to trigger a media player fails to establish a synergy between the same. Consequently, it would be beneficial to have a system in which facial recognition tools work in concert with media players to predict and/or influence specific outcomes.

Furthermore, the prior art fails to assess audience averages and/or to trigger or append data regarding the same. Furthermore, existing tools utilize a 1 to 1 relationship with content provided, thereby failing to take advantage of economies of scale. Consequently, it would be beneficial to have a system for and method of assessing audience averages and for triggering and/or appending data regarding the same. Furthermore, it would be beneficial to have a system that utilizes singular and crowd averages to deliver and record metrics and/or to garner attraction and record attention. Furthermore still, it would be beneficial to have a mass delivery system for efficiently and effectively distributing content and/or to specify material to hyper local markets. It would still further be beneficial to have a system for and/or a method of recording and maintaining A/B testing at a hyper local level.

### SUMMARY

The present invention comprises a system for and methods of identifying potential audiences, determining appropriate marketing materials for the audience, and determining the effectiveness of the marketing materials. In some embodiments, the system identifies one or more person (an “audience”) in close proximity to one or more display device, such as a monitor, a display surface, or any other means of displaying marketing materials now known or later developed (each a “display device”). In some embodiments, the system ascertains certain information about the audience, such as the size of the audience, the position and orientation of each audience member relative to the display device, movement of each audience member relative to the display device (i.e. moving towards, moving away from, jockeying for position next to, etc.), as applicable, predicted demographic information of one or more audience member, predicted mood of one or more audience member, and the like, thereby determining a classification for one or more member of the audience. In some embodiments, the system creates an aggregate classification of the audience based on the one or more individual classifications. In some embodiments, individual classifications are weighted. In some embodiments, weighting of each individual classification is determined based on a variety of factors, including timing, environmental, historical, and/or business factors or the like. In some embodiments, the system compares the aggregate classification of the audience to classifications of a plurality of marketing materials so as to determine a predicted effectiveness of each of the marketing materials.

In some embodiments, the system is a targeted-advertising system that is configured to display to one or more individual, such as one or more member of an audience, marketing materials that are predicted to be effective for the one or more individual and/or for at least part of a group of individuals (in each case, the “audience”). In some embodiments, the system obtains information from the audience while the marketing materials are displayed so as to ascertain a perceived effectiveness of the marketing materials. In some embodiments, the system obtains information from the audience before and/or after the marketing materials are displayed so as to assist in ascertaining a perceived effectiveness of the marketing materials. In some embodiments, audience information is associated with the displayed marketing materials so as to assist in more accurately predicting effectiveness of marketing materials in the future.

In some embodiments, the system of the present invention is a total marketing hardware and software system capable of providing a direct-targeting advertisement solution. In some embodiments, the system utilizes one or more device, such as a digital video camera, for obtaining information associated with an audience and/or the audience's surroundings. In some embodiments, the system is configured to parse information, such as one or more image, to define pertinent information associated with the audience and/or the environment, such as demographic detail, perceived mood, environmental factors, and the like. In some embodiments, the system is configured to trigger, such as through a computing device and display device, display of loaded content (video/audio/static/etc.) that is determined to be appropriate for the audience based on demographic and/or circumstantial information and/or otherwise (each occurrence being a “presentation”). In some embodiments, the system includes a machine learning algorithm for assessing the effectiveness of the displayed content, thereby assisting the system in determining appropriate content in the future, such as for the same and/or different audiences and/or in similar and/or different circumstances.

In some embodiments, effectiveness of a presentation is determined, at least in part, based on attachment rate and dwell time associated with the presentation. In some embodiments, timing and system information associated with effectiveness of each presentation is utilized to aggregate billing, such as to third parties, and/or to provide other informative statistics, such as effectiveness of marketing materials and/or delivery methods.

In some embodiments, the system is a stand-alone system, such as in a public environment, and/or loaded content is associated with any number of potential advertisers. In some embodiments, the system augments existing systems, such as augmenting a retail display, and/or loaded content is limited based on location, time of day, and/or other factors. In some embodiments, the system is configured to augment and/or provide a retail display device and digital video camera connected to a computing device. In some embodiments, the system is configured to display generic and/or targeted content, such as in a loop, until the system triggers the display of different content. In some embodiments the system triggers targeted content and/or generic content upon recognition of audience and/or circumstantial information.

In some embodiments, the system includes a local hardware “box”, such as hardware associated with a local kiosk. In some embodiments, the box includes a camera, a processing device, such as a computer, a display device, such as a monitor or similar device, and/or a communication device, such as a device for establishing and maintaining internet network access. In some embodiments, the box is in data communication with a cloud-based content management system. In some such embodiments, the content management system causes the box to display an advertisement loop, such as an advertisement loop loaded onto the box and identified by the content management system and/or an advertisement loop provided to the box by the content management system. In some embodiments, the advertisement loop is configured to attract attention of an individual identified as being in the vicinity of the box. In some embodiments, the system launches an algorithm to determine the age range, race, gender, and emotion of the individual so as to predict demographics or other information associated with the individual. The system then searches for content considered appropriate for the individual and determines the effectiveness of such content.

In some embodiments, effectiveness of content is determined based on attachment and/or dwell time. In some embodiments, attachment is determined based on the individual looking directly at the content for more than 1 second. In some embodiments, dwell is determined based on attachment that lasts for 3 to 30 seconds. In some embodiments, dwell resets to zero upon the individual breaking attachment. In some embodiments, dwell is aggregated for multiple individuals and/or for multiple content. In some embodiments, aggregated attachment and/or dwell is utilized to assess effectiveness and/or to properly bill advertisers based on individual interactions rather than just content played.

The foregoing and other objects are intended to be illustrative of the invention and are not meant in a limiting sense. Many possible embodiments of the invention may be made and will be readily evident upon a study of the following specification and accompanying drawings comprising a part thereof. Various features and subcombinations of invention may be employed without reference to other features and subcombinations. Other objects and advantages of this invention will become apparent from the following description taken in connection with the accompanying drawings, wherein is set forth by way of illustration and example, an embodiment of this invention and various features thereof.

### BRIEF DESCRIPTION

A preferred embodiment of the invention, illustrative of the best mode in which the applicant has contemplated applying the principles, is set forth in the following description and is shown in the drawings and is particularly and distinctly pointed out and set forth in the appended claims.

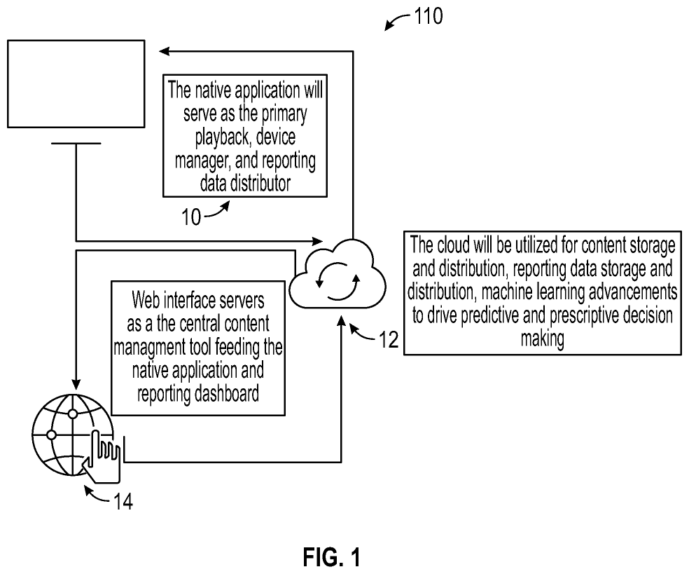

FIG. 1 is a flow diagram of an embodiment of the present invention.

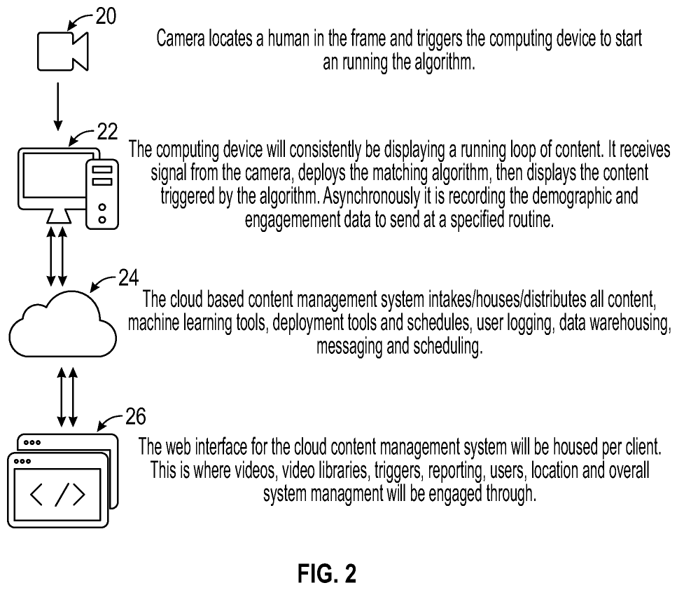

FIG. 2 is a flow diagram of an embodiment of the present invention.

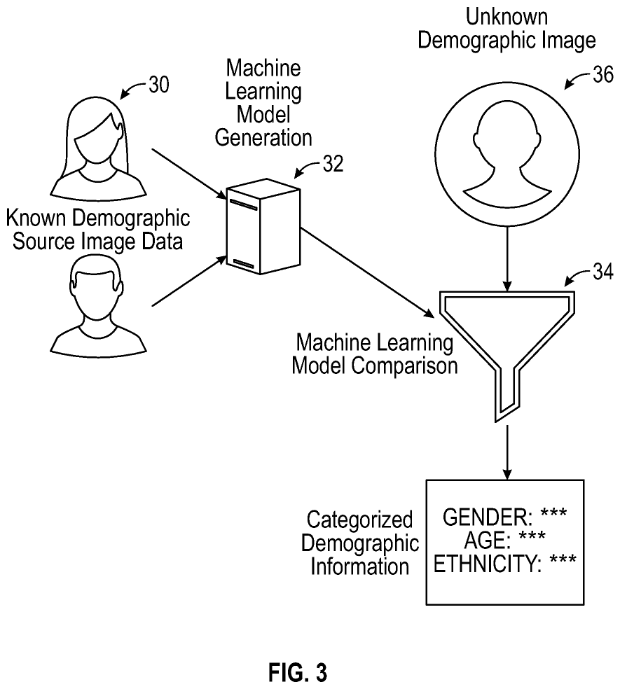

FIG. 3 is a flow diagram associated with a machine-learning recognition-growth algorithm of an embodiment of the present invention.

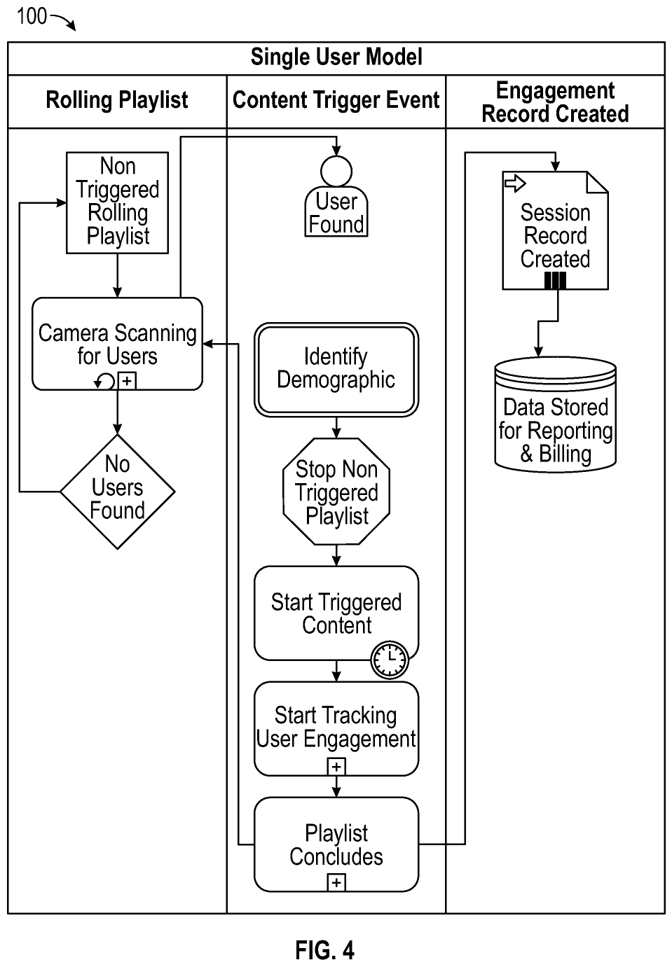

FIG. 4 is a flow diagram of an embodiment of the present invention.

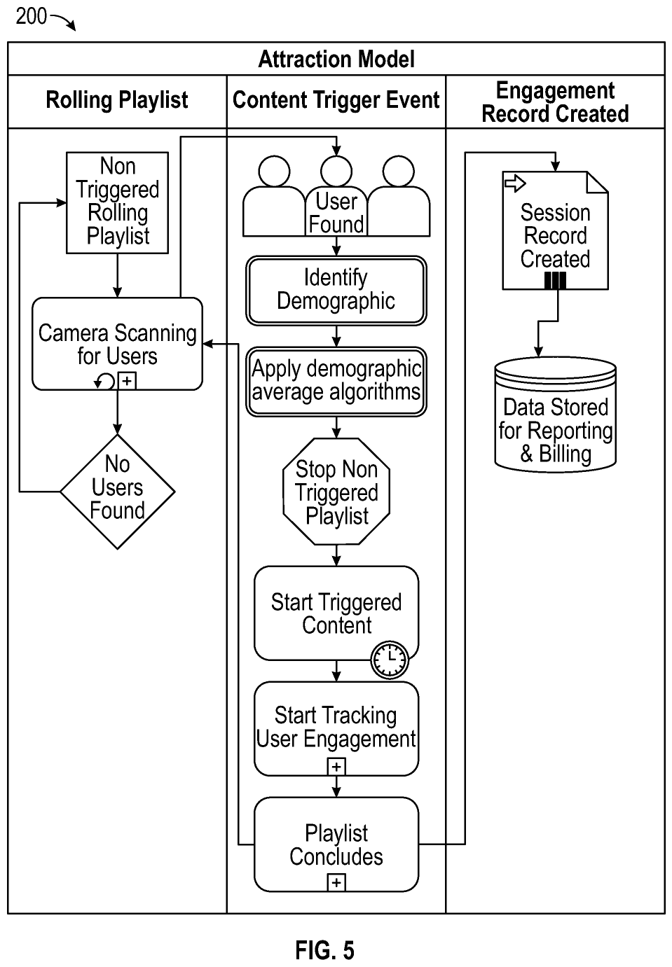

FIG. 5 is a flow diagram of an embodiment of the present invention.

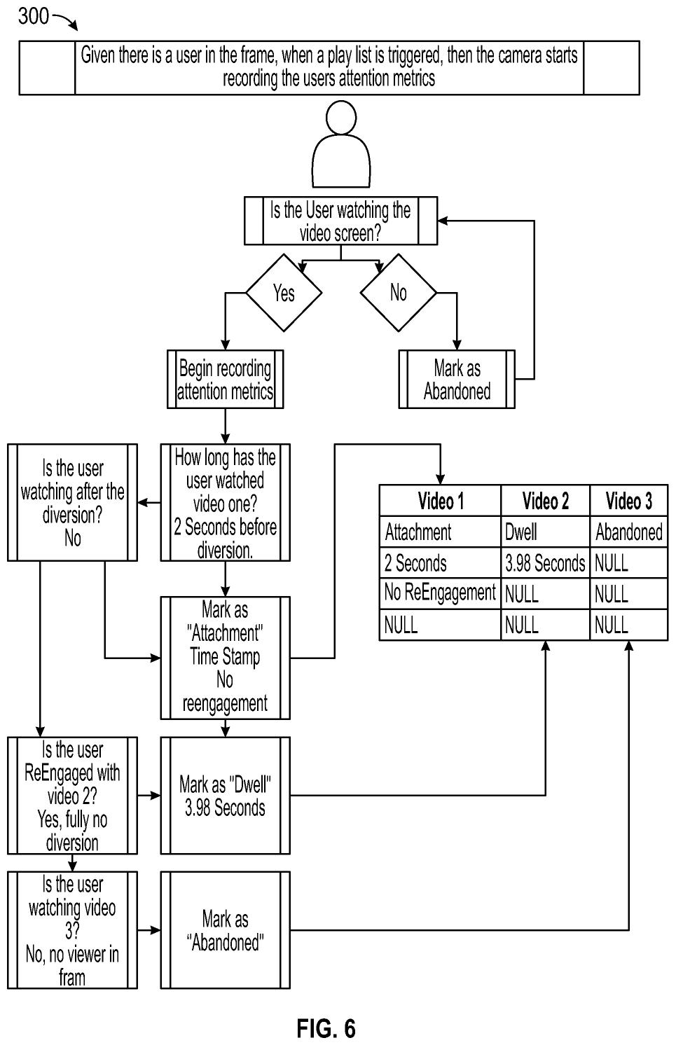

FIG. 6 is a flow diagram of an embodiment of the present invention.

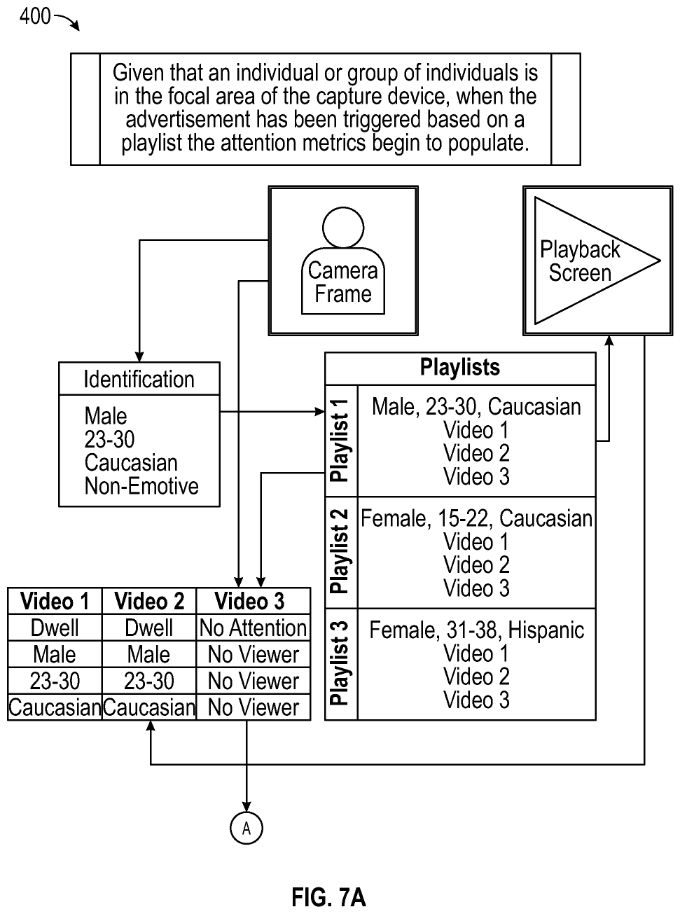

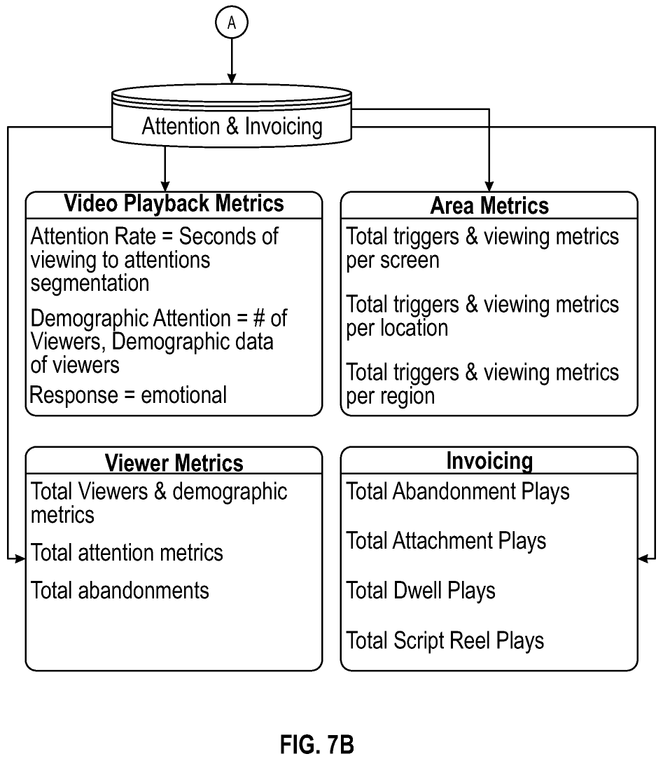

FIGS. 7A and 7B show a flow diagram of an embodiment of the present invention.

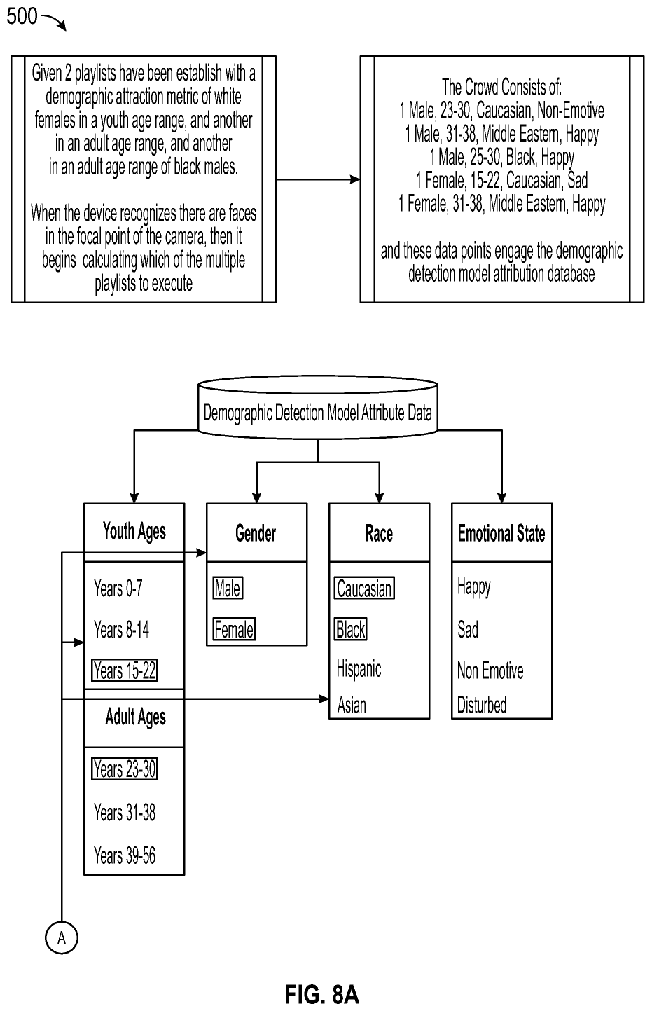

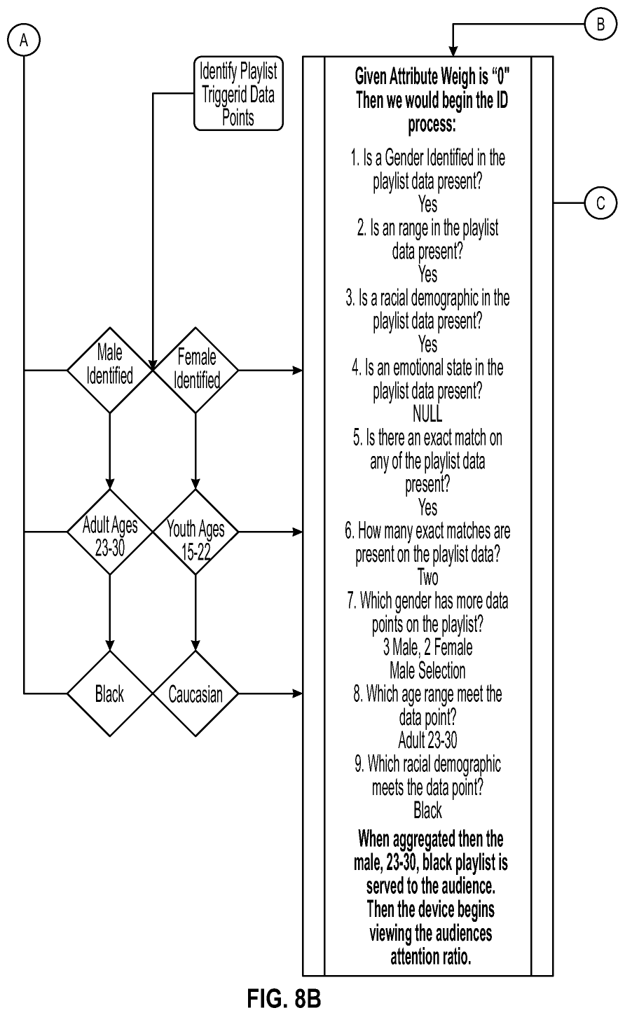

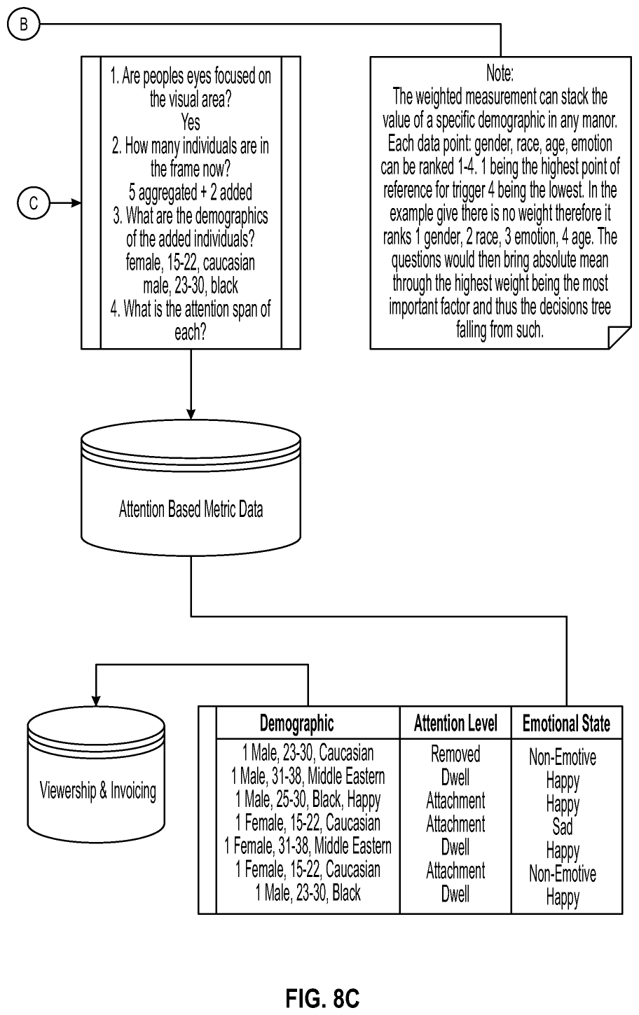

FIGS. 8A and 8B show a flow diagram of an embodiment of the present invention.

### DETAILED DESCRIPTION

As required, a detailed embodiment of the present invention is disclosed herein; however, it is to be understood that the disclosed embodiment is merely exemplary of the principles of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

Referring to FIG. 1, some embodiments of the present invention include a native application 10 serving as a primary playback distributor, device manager, and/or reporting data distributor. In some embodiments, the native application 10 is in data communication with a cloud computing system 12. In some embodiments, the cloud computing system 12 is utilized for content storage and distribution. In some embodiments, the system is configured to report data storage and data distribution. In some embodiments, the system includes machine learning advancements to drive predictive and prescriptive decision making.

Still referring to FIG. 1, some embodiments of the present invention include a web interface 14 in data communication with the cloud computing system 12. In some embodiments, the web interface 14 serves as a central content management tool, such as for feeding the native application 10 and/or for reporting content use and/or effectiveness, such as through a reporting dashboard.

Referring to FIG. 2, some embodiments of the present invention include a camera 20 for locating one or more individual in close proximity to one or more display device. In some embodiments, the system utilizes one or more other sensor in addition to and/or instead of a camera 20. In some embodiments, the system triggers an identification and/or classification algorithm upon identifying one or more individual. In some embodiments, the system employs a matching algorithm for matching content to one or more identified individual (i.e. based on previous information associated with the identified individual) and/or for matching content associated with one or more classification (i.e. based on similar classifications of individuals).

In some embodiments, the classification algorithm identifies one or more potential classification associated with the one or more individual. In some embodiments, the classification algorithm creates an aggregate and/or composite classification based on a group of individuals and/or based on targeted individuals within a group. In some embodiments, targeted individuals in a group are determined based on predetermined factors, such as preferred target demographics (i.e. desirable marketing groups), position and orientation of such members (i.e. facing a display vs. facing away from a display), observed interaction (i.e. observed attachment and dwell vs. observed detachment and/or observed failure to attach), or the like.

Still referring to FIG. 2, some embodiments of the present invention include a computing device 22 in data communication with a display device for displaying content. In some embodiments, the computing device 22 is in data communication with the camera 20 and/or other sensing device, thereby enabling the computing device 22 to determine attachment and dwell associated with displayed content.

In some embodiments, the system includes a default mode for displaying a continuous loop of content, such as predetermined content. In some embodiments, the system is configured to transition from the default mode to a targeting mode upon identifying a targeted individual and/or identifying a triggering circumstance (such as an individual moving into close proximity to a display device). In some embodiments, the system is configured to deploy a matching algorithm upon identifying a triggering circumstance. In some embodiments, the system is configured to display content triggered by the matching algorithm while recording engagement data (i.e. attachment, dwell, etc.) associated with such content. In some embodiments, engagement data from a first display event is utilized by the matching algorithm for predicting engagement associated with a second display event.

Still referring to FIG. 2, some embodiments of the present invention include a cloud based content management system. In some embodiments, the management system controls and/or otherwise influences retrieval of, storage of, and/or distribution of content, machine learning tools, deployment tools and schedules, user credentials, data other than content (such as engagement data, identity data, demographic data, mood data, environmental data, and the like), messaging, and/or scheduling. In some embodiments, the management system is in data communication with one or more computing device 22 of the system, such as a plurality of computing devices 22 distributed throughout a plurality of retail environments, public locations, or the like.

Still referring to FIG. 2, some embodiments of the present invention include a web interface associated with a cloud based content management system 24. In some embodiments, the web interface enables management of the system, such as management of videos, video libraries, triggers, reporting, users, locations, and the like. In some embodiments, the web interface is configured to monitor and/or control content provided to and/or received from one or more computing device and/or information associated with the same.

In some embodiments, the system is a cloud based intelligent content management system triggered by cognitive and demographic machine leaning/artificial intelligence algorithmic patterns. In some embodiments, the algorithmic patterns are associated with images or other information caught by a digital camera 20 and/or other sensing device. In some embodiments, information is processed locally by a computing device 22 that determines which content is displayed on a visual monitoring device. In some embodiments, the local computing device 22 records demographic and engagement data associated with displayed content. In some embodiments, the system provides recorded information to a cloud data storage system for data parsing and, when appropriate, delivery to a web portal for content management, predictive/prescriptive analysis, billing, and/or reporting.

In some embodiments, a “digital camera” 20 is any device that is capable of digitally recognizing a face in a video frame and being able to return that captured frame to the computing device 22. In some embodiments, a “computing device” 22 is any device capable of computing the needs of connecting to the internet, loading, and running system software (such as AGNOS software). In some embodiments, a “display device” is any device capable of displaying content, such as advertisement materials, sent to it by the computing device 22. In some embodiments, a “cloud based content management system” 24 is a cloud based service that allows software to be deployed, aggregated, populated, and/or assimilated via FTP and or web based interface.

In some embodiments, the system is configured to determine whether content or other features of the invention is successful in attracting attention. In some embodiments, the system is considered to “attract” attention when a digital camera 20 captures one or more audience member and/or one or more other individual turning to face and/or otherwise making eye contact with a display device. In some embodiments, the system uses a many to one algorithm which allows the system to capture those looking towards a display monitor while also capturing those who are not looking towards the display monitor. In this way, the system is capable of assessing probability of attracting attention of the entire audience and/or a portion thereof. In some embodiments, content is selected by the system to promote attraction. In other embodiments, content is selected by the system after attraction, such as to promote attachment.

In some embodiments, the system is configured to determine whether content or other features of the invention is successful in maintaining the attention of one or more individual and/or group (“attachment”), such as after attraction. In some embodiments, the system is configured to determine “attachment” after a digital camera 20 or other device captures a human facing and/or maintaining eye contact with a display device for a predetermined first period of time, such as more than 1 second. In some embodiments, attachment is determined when the eyes and face are both directed towards a display monitor. In some embodiments, attachment is not determined if the eyes and face are not in unison. In some embodiments, attachment triggers content. In some embodiments, content is selected by the system to promote attachment. In either event, attachment initiates an engagement.

In some embodiments, the system is configured to determine whether content or other features of the invention is successful in maintaining the attachment for one or more individual and/or group (“dwell”). In some embodiments, the system is configured to determine “dwell” is associated with engagement for a predetermined second period of time, such as the duration of substantially an entire, or a substantial portion of a, playlist, presentation, or segment thereof. In some embodiments, the predetermined second period of time is more than 3 seconds. In some embodiments, dwell is determined based on the consistent capture of a human face and/or eyes by a digital camera 20 facing and/or being directed towards a display device for the predetermined second period of time.

In some embodiments, the system is configured to determine whether content or other features of the invention is associated with a negative reaction, such as a “rejection” of the same. In some embodiments, the system is configured to utilize a facial emotional response algorithm and/or one or more other algorithm to anticipate a rejection and/or to assist in determining whether a failure to attract, failure to attach, and/or termination of an engagement (i.e. “disengagement” and/or “departure”) is associated with a rejection. In some embodiments, the system is configured to determine a cause of the rejection and/or to compare attraction, attachment, and/or dwell pre and post rejection. In some embodiments, a rejection is determined upon observing a negative response, such as a negative repositioning of the body, a negative facial gesture, or the like. In some embodiments, a rejection is determined upon observing a negative response immediately following attachment and/or immediately following a transition, such as a change of content or an identified emotional, social, financial, or other trigger associated with such content.

In some embodiments, “disengagement” or “departure” is determined based on the act of a human face turning away from or otherwise moving away from a display device during an engagement and/or eyes being directed away from the same. In some embodiments, the system is configured to assist in determining whether disengagement is associated with a rejection. In some embodiments, “reengagement” is associated with an individual engaging with a display device after disengaging from the display device. In some embodiments, duration and frequency of engagement and disengagement is associated with one or more content, individual, demographic, and/or circumstance so as to assess effectiveness of content. In some embodiments, a “segmented dwell” is associated with aggregation of an initial engagement with one or more reengagement.

In some embodiments, the present invention includes and/or utilizes algorithms, such as machine learning algorithms, for detecting facial elements to determine a human's race, age, gender, emotion, and the like. In some embodiments, the algorithm is based in a cloud storage environment which is consistently compiling information and using such information to increase accuracy and reliability of detection and classification methods (i.e. training itself to become more advanced and accurate).

Referring to FIG. 3, some embodiments the system include a machine learning model comparison algorithm that compares an unknown demographic image 36 with a plurality of known demographic source images 30, thereby enabling the unknown demographic image 36 to be categorized into one or more demographic. In some embodiments, the system is configured to assign a reliability factor associated with each demographic categorization. In some embodiments, the system includes and/or is in communication with a machine learning model generation system 32 that is capable of sorting images, providing images to the machine learning model comparison algorithm 34, and/or receiving data from the same.

In some embodiments, a cloud content management system is utilized to trigger one or more algorithm. In some embodiments, the cloud content management system builds and/or has access to a content library, such as a video library. In some embodiments, the management system links specific content, such as specific videos, to specific observed and/or predicted demographics, conditions, scenarios, or the like and/or otherwise facilitates association of the same so as to be triggered by a machine learning algorithm. In some embodiments, the system utilizes a backend library, such as a library based in a cloud computing environment, to create playlists based on specific demographic inputs to play specific content. In some such embodiments, the system is configured to weight a number of factors, including demographic perimeters (i.e. gender, age, race, etc.), and trigger off one or multiple averages with weighted results to give more granular control. In some embodiments, the system identifies one or more trigger for initiating a respective subroutine. In some embodiments, the system includes algorithms associated with one or more interactive trigger, such as headcount trigger, body language triggers, color hex triggers, speech triggers, and the like.

In some embodiments, the content management system develops and/or deploys a playlist. In some embodiments, the playlist includes previously linked and/or triggered content. In some embodiments, the computing device utilizes one or more machine learning algorithm for deploying the playlist triggered and/or for determining effectiveness of the same. In some embodiments, the computing device records demographic information, engagement information, hardware system information, and the like and reports it back to a cloud content management system or the like. In some such embodiments, reported information is parsed for computer learning and/or for otherwise reporting or recording information. In some embodiments, reported information is made available to a cloud content management system, such as for reporting, billing, prescriptive analytics, predictive analytics, or the like.

Referring to FIG. 4, an exemplary workflow model for a single user 100 (single audience member) is shown. In some embodiments, the model utilizes and/or includes a rolling playlist, such as a playlist that is anticipated to attract attention of one or more potential audience member. In some embodiments, the rolling playlist includes non-triggered or pre-set media content displaying on a screen. In some embodiments, a camera monitors a visual field within viewing distance of the screen. In some such embodiments, the model displays a rolling playlist until the camera detects a user within the visual field.

Upon detecting a user within the visual field, the model shown in FIG. 4 executes a content trigger event. In some embodiments, the content trigger event includes imaging the user, such as by obtaining an unsaved snapshot of the user's face. In some embodiments, the model utilizes a snapshot to deliver a set of base model data using facial recognition algorithms now known or later developed. In some embodiments, such data includes demographic data (such as age, gender, race, etc.), mood data, and/or the like (each being “demographic information”). In some embodiments, the model stops the rolling playlist and executes a triggered content associated with a user's demographic information. In some embodiments, the model utilizes the demographic information to determine which triggered content to display. In some embodiments, the demographic information is weighted in making such a determination.

In some embodiments, the model continues to monitor the user within the visual field. In some embodiments, the model monitors the user's engagement with the triggered content, including monitoring the user's facial responses and/or eye movements such as to determine responses associated with the content. In some embodiments, upon conclusion of the triggered content, the model plays generic content, such as the original rolling playlist and/or a new rolling playlist. In some embodiments, the model stores information associated with a session record, such as by storing demographic information, user engagement information, or the like.

Referring to FIG. 5, an exemplary workflow model for multi-users 200 (multiple audience members) is shown. In some embodiments, such a model is described as an attraction model. In some embodiments, a rolling playlist and/or a session record are similar to those associated with a single user model. In some embodiments, a rolling playlist displays content until a camera identifies users within a visual field. In some embodiments, the model captures one or more image of the users within the visual field. In some embodiments, the model utilizes facial recognition (or similar) technology to determine the number of users within the visual field. In some embodiments, the model utilizes the snapshot to deliver a set of base model data for at least some of the users, such as by using facial recognition algorithms for each user. In some embodiments, such data includes demographic data (such as age, gender, race, etc.), mood data, and/or the like (each being “demographic information”). In some embodiments, demographic information associated with one or more user is weighted and/or averaged utilizing demographic average algorithms. In some embodiments, the resulting normalized dataset is utilized to determine which triggered content to display.

In some embodiments, the model continues to monitor the one or more user within the visual field. In some embodiments, the model monitors each user's engagement with the triggered content, including monitoring each user's facial responses and/or eye movements, such as to determine effectiveness of the content with each user. In some embodiments, the model returns to playing a rolling playlist upon conclusion of the triggered content.

Referring to FIG. 6, a flow diagram associated with an attention metrics model 300 of certain embodiments of the present invention is shown. In some embodiments, the attention metrics model begins when one or more user is present within a visual field. When a user is present, the model utilizes eye tracking to determine if a user is watching the video screen. It will be appreciated that the model utilizes one or more eye tracking means now known or later developed. When a user is within the visual field but is not watching the screen, the model marks the present session as abandoned and continues to monitor the visual field for a user watching the screen. In some embodiments, the model begins recording attention metrics upon detecting one or more user engaged with the screen.

Still referring to FIG. 6, the model incorporates recording various metrics. In some embodiments, the metrics are attention metrics. In some embodiments, the attention metrics include biophysical metrics associated with one or more user. In some embodiments, these metrics include eye tracking, expression, time spent watching screen, reengagement on the screen, diversion from screen viewing, and/or the like. It will be appreciated that the present invention utilizes one or means now known or later developed for determining one or more biophysical metric.

In some embodiments, the model utilizes the attention metrics to monitor the time spent viewing the screen. In some embodiments, the model is determining the duration of viewing for an entire play list, while in others the model is determining the duration of viewing for a single ad within a play list. In some embodiments, the model tracks predefined duration of viewing. In some embodiments, the model utilizes the predefined durations of viewing to label the user's engagement with each video in the play list. In some embodiments, the predefined duration is 2 seconds.

Still referring to FIG. 6, in some embodiments the model assesses and stores user attentiveness. This assessment is variable. In some embodiments, the model assesses when a user first engages with an advertisement. Such an engagement can also be referred to as attachment. The model then stores that the user was first attached to this advertisement along with the length of time the user watched the advertisement prior to the advertisement changing. In some embodiments, upon moving from a first video to a subsequent video, the model continues to assess user attentiveness. If a user reengages with a subsequent video, the model stores that the user has continued to dwell on the video. In some embodiments, where the user stops watching the subsequent video, the model stores that the user has abandoned.

Referring to FIGS. 7A and 7B, a flow diagram associated with an attention model 400 of certain embodiments of the present invention is shown. In some embodiments, the attention model serves media content based on demographic information of users. The model utilizes a camera and a playback screen, along with pre-built playlists. The model monitors the camera visual field until one or more users are within the visual field. The model then assesses demographic data associated with the one or more user. It will be appreciated that the model utilizes one or more means now known or later developed for assessing demographic data. In some embodiments, such demographic data is data which is readily apparent through a visual field, such as, but not limited to, gender, age, ethnicity, and facial expression. The model then utilizes one or more of the demographic data to generate a general identification scheme about the one or more user.

In some embodiments, the model contains one or more playlists. In some embodiments, the playlists are created by an administrator of the system. In some embodiments, the playlists are auto-generated. In some embodiments, the playlists consist of one or more pieces of media content. In some embodiments, each playlist is designated with one or more ideal demographic data target. In some instances, such demographic data target is determined on a playlist level, while in others such demographic data target is determined on a media content level. In some embodiments, the model dynamically builds a playlist based on the identification scheme and demographic data target of one or more media content.

The model then chooses a playlist and begins to serve the content to the one or more user. In some embodiments, the model tracks the attentiveness and expression of the one or more user during playback. In some embodiments, such metrics are stored to determine the effectiveness of the content.

In some embodiments, the model also includes various metrics to determine effectiveness's of the content. Such metrics may include video playback metrics. Video playback metrics evaluate the user interaction with the video. Such interactions include, but are not limited to, the user attention rate, the overall attention of the group (demographics attention), and the emotional response. The user attention rate evaluates the seconds of viewing to all attention segments. In some embodiments, the user attention rate evaluates the seconds of viewing to the playlist as a whole. The demographics attention assesses the overall number of viewing and the demographic data of those viewers. Such demographic data can be the same demographic data utilized to select the play list, or it may be different demographic data. The emotional response may be targeted to the emotional response of a single user within a group, a single demographic within a group, or towards a weighted aggregate of the entire group.

Additionally, the model may include other metrics. One other metric that is configurable within the model is area metrics. Area metrics determine the effectiveness of the physical location at which the media content is being played. The area metrics are configurable to assess total triggers of the model and the viewing metrics on a per screen basis, per location basis, and a per region basis. This allows for a holistic assessment of demographic targeting and user engagement in fine detail. One other metric that is configurable within the model is viewer metrics. View metrics track the viewings and demographics of the viewers. The viewer metrics are configurable to assess total viewers and their demographics, total attention metrics, and total abandonments. Another metric that is configurable within the model is invoicing. In some embodiments, the invoicing is set to a flat per play fee. In other embodiments, additional metrics are included to evaluate pricing based on user interaction and model effectiveness. Such additional metrics include, but are not limited to, total abandonment plays, total attachment plays, total dwell plays, and total script reel plays.

Referring to FIGS. 8A-8C, a flow diagram associated with an attraction model 500 of certain embodiments of the present invention is shown. The attraction model is configurable to assess potential faces within a visual field and serve media content to the individuals based on data read from the visual field. In some embodiments, the attraction model assesses only a single individual within the visual field. In some embodiments, the attraction model assesses multiple individuals within the visual field. In yet other embodiments, the attraction model assesses a dynamic number of individuals within the visual field, which may change during the execution of the model. It will be appreciated that the model utilizes one or more means now known or later developed for obtaining and assessing information associated with the one or more individuals.

Where there are multiple individuals within the visual field, the model assesses various demographic data of the individuals. In some embodiments, the demographic data includes, but is not limited to, gender, ethnicity, age, and emotional state. In some embodiments, the model is configurable to aggregate the demographic data, such as demographic data that has been stored by the system. It will be appreciated that the model utilizes one or more means now known or later developed for aggregating the demographic data. In some embodiments, the aggregation identifies which of a list of preset data categories are satisfied by the individuals within the visual field. In some embodiments, the model utilizes the aggregation to select pre-defined playlists to serve to the one or more individuals.

In some embodiments, the model is configurable to determine which of multiple eligible playlists to serve. In some embodiments, the model places weights, or priorities, on the demographic data to decide between multiple playlists. First, the model identifies which pieces of demographic data are present within the overall demographic data set. The model then looks for any playlists which are an exact match for any of the playlist data present. The model then assesses how many playlists are exact matches on the data. If only one exact match exists, the matching playlist is served. If two or more playlists are exact matches, the model uses weighted prioritization to determine which playlist to select. In some embodiments, a user determines which demographic data to prioritize. In yet other embodiments, the model has a default prioritization. The model then processes the priority ranks, determining for each set of demographic data which demographic is most prevalent and narrowing the list of potential playlists by this demographic. Once the list of potential playlists is narrowed to one, the model checks to ensure the playlist meets all of the remaining demographics and serves the playlist to the individuals.

While the playlist is being displayed to the individuals, the model tracks various interaction metrics of the individuals. Such metrics include individual attention to the playlist. The metrics include, but are not limited to, determination of if the eyes of the individuals are focused on the content, how many individuals are within the visual field, if any individuals have left or joined the initial group, the demographics of joined or departed individuals, and the attention time span on each individual. This data is then processed by the attention metrics.

In a first example, the system of the present invention observes five individuals and classifies them as follows:

Male, 25-30, Caucasian, Non Expressive;

Male, 30-35, Middle Eastern, Happy;

Male, 25-30, African American, Happy;

Female, 20-25, Caucasian, Sad; and

Female, 30-35, Middle Eastern, Happy.

Assuming in the first example the system assigns greater weight to gender than to other factors, the system will generate an aggregate classification of males who are aged 25-30 and/or who are happy, thereby triggering a playlist directed to the same. In some embodiments, the playlist is aggregated by acquiring content directed at males and then fine-tuning the content by focusing on acquiring content directed at an age range of 25-30 and/or at an expressiveness of happy. In some such embodiments, the system does not filter content based on race due to the spread.

Assuming in the first example the system assigns greater weight to factors other than gender, different playlists may be triggered. For instance, if expressiveness is weighted heavier, the system will generate an aggregate classification of happy Middle Easterners who are aged 30-35 and the playlist will be aggregated by acquiring content directed to happy individuals and then fine-tuning the content by acquiring content directed at Middle Easterners aged 30-35. If age is weighted heavier, some embodiments of the system will generate an aggregate classification of happy Middle Easterners who are aged 30-35 while other embodiments of the system will generate an aggregate classification of males aged 25-30, depending on how the other factors are weighted.

In some embodiments and examples, some classifications within one or more group are weighted heavier than other classifications. For instance, assuming the female classification is weighted heavier than the male classification, some embodiments of the present invention in some examples will create an aggregate classification including females while other embodiments in other examples will create an aggregate classification including males, depending on the disparity of the weighted difference between male and female, the weight given to other factors, and the potential weight disparity of classifications associated with each factor.

The present invention further includes methods for determining performance of content, such as by determining when and where content is being played (each a “presentation”) and attraction, attachment, dwell, and rejection associated with the same. In some embodiments, the system is configured to determine circumstances associated with performance of one or more presentation and/or to identify trends associated with the content, the location, the circumstances, and the like.

In a second example, the system of the present invention determines that a first content playlist is successful in attracting young women in first and second regions, based on high attachment and dwell rates being observed with minimal rejection rates in the regions, but the same playlist is much less successful in attracting young women in a third region. Assuming the first content playlist is classified as Females, 20-25, white, happy, the classification would appear to be accurate in the first and second regions but not in the third region. In some embodiments, the content is classified differently for each region based on observed successfulness of the content in the same or similar regions. In some embodiments, the content is adjusted for the third region and/or for one or more other region similar to the third region.

Assuming in the second example the content attracted women aged 15-20 in the first region and women aged 20-25 in the second region, some embodiments of the present invention are configured to ascertain whether the different demographic is associated with a different populous and/or whether the different demographics are associated with circumstances associated with the respective presentations. In some embodiments, the system is configured to tailor one or more presentation to one or more demographic, populous, and/or circumstance.

In some embodiments, the system includes a content distribution module for assisting in distribution of content. In some embodiments, the content distribution module enables a user and/or advertiser to identify a plurality of display devices, anticipated demographics, anticipated attachment rate for anticipated demographics, and the like. In some embodiments, the system is configured to allow a content owner and/or a content manager to associate content with one or more display device, such as to identify a display device on which content can and/or cannot be displayed. In some embodiments, the system enables users to identify circumstances and/or demographics associated with triggering (or not triggering as the case may be) associated content. In some embodiments, the system is configured to associate each display device with a location, such as a region of a country, surrounding businesses or activities (i.e. stores, museums, parades, farmer markets, etc.), locations within a building and/or relative to a building (i.e. aisle number, distance from front entrance, distance from food court, etc.), surrounding items, and/or the like.

In some embodiments, the content distribution module this is a multiplied content distribution model. In some embodiments, the model uses a cloud-based centralized content management system. In some embodiments, an unlimited number of properties are singularly or simultaneously updated based upon the needs of the overall management of distributed content. In some embodiments, demographic triggers, content within playlists, and/or playlists themselves are maintained by a single user with administrative privileges. In some embodiments, each point of distribution adopts changes made to the centralized content management system. In some embodiments, such changes are wrapped in a software package and sent to the various points of distribution via cloud based upload and download systems. In some embodiments, each point of distribution ingest and expel layered software images to trigger the new content while expelling the old contenting making the seamless transition without undertaking a massive bandwidth needs. In some embodiments, such a softball configuration is sustainable even in an internet outage.

In some embodiments, a configuration including a reporting and billing module is contemplated. In some embodiments, the reporting and billing model is configured to report upon plays, attach, and dwell times. In some embodiments, eye tracking recognition algorithms provide information that is time stamped and demographic stamped, showing who is watching and for how long. In some embodiments, such information is aggregated, protecting specific user identities. In some embodiments, the module is configured to utilize the information to generate monetary costs for each advertiser and/or brand associated with a piece of content based upon the experience level or time of interaction of users in contact with the point of distribution.

In the foregoing description, certain terms have been used for brevity, clearness and understanding; but no unnecessary limitations are to be implied therefrom beyond the requirements of the prior art, because such terms are used for descriptive purposes and are intended to be broadly construed. Moreover, the description and illustration of the inventions is by way of example, and the scope of the inventions is not limited to the exact details shown or described.

Although the foregoing detailed description of the present invention has been described by reference to an exemplary embodiment, and the best mode contemplated for carrying out the present invention has been shown and described, it will be understood that certain changes, modification or variations may be made in embodying the above invention, and in the construction thereof, other than those specifically set forth herein, may be achieved by those skilled in the art without departing from the spirit and scope of the invention, and that such changes, modification or variations are to be considered as being within the overall scope of the present invention. Therefore, it is contemplated to cover the present invention and any and all changes, modifications, variations, or equivalents that fall within the true spirit and scope of the underlying principles disclosed and claimed herein. Consequently, the scope of the present invention is intended to be limited only by the attached claims, all matter contained in the above description and shown in the accompanying drawings shall be interpreted as illustrative and not in a limiting sense.

Having now described the features, discoveries and principles of the invention, the manner in which the invention is constructed and used, the characteristics of the construction, and advantageous, new and useful results obtained; the new and useful structures, devices, elements, arrangements, parts and combinations, are set forth in the appended claims.

It is also to be understood that the following claims are intended to cover all of the generic and specific features of the invention herein described, and all statements of the scope of the invention which, as a matter of language, might be said to fall therebetween.

1. A method for targeting advertisements, the method comprising:
detecting a user within a visual field associated with a first display device;
determining a first set of information, the first set of information comprising demographic information associated with the user;
triggering the first display to display a first advertisement, the first advertisement being selected based on the first set of information; and
determining a second set of information while the first display is displaying the first advertisement,
wherein the second set of information is associated with effectiveness of the first advertisement.

2. The method of claim 1, wherein the demographic information includes at least one of gender information, age information, ethnicity information, and emotional information.

3. The method of claim 2, wherein the first advertisement is selected based on at least one of gender information, age information, ethnicity information, and emotional information.

4. The method of claim 1, wherein the first advertisement is selected based on two or more demographic factors, at least one demographic factor being one of gender information, age information, ethnicity information, and emotional information.

5. The method of claim 4, wherein the first advertisement is selected based on pre-selected weighted values assigned to each of the two or more demographic factors.

6. The method of claim 5, wherein the first advertisement is selected from a plurality of advertisements, each advertisement of the plurality of advertisements being associated with a demographic target, wherein each demographic target is associated with a demographic factor.

7. The method of claim 6, wherein the second set of information comprises viewer metrics, at least one viewer metric being one of attention rate, demographic attention, emotional response, and location.

8. The method of claim 7, further comprising determining effectiveness of the first advertisement based on one or more viewer metrics.

9. The method of claim 1, wherein the second set of information comprises viewer metrics, at least one viewer metric being one of attention rate, demographic attention, emotional response, and location.

10. The method of claim 9, further comprising determining effectiveness of the first advertisement based on one or more viewer metrics.

11. A method for targeting advertisements, the method comprising:
detecting one or more user within a visual field associated with a first display device;
determining a first set of information, the first set of information comprising demographic information associated with the one or more user;
generating an augmented set of information from the first set of information;
triggering the first display to display a first advertisement, the first advertisement being selected based on the augmented set of information; and
determining a second set of information while the first display is displaying the first advertisement,
wherein the second set of information is associated with effectiveness of the first advertisement.

12. The method of claim 11, wherein the demographic information includes at least one demographic factor, at least one demographic factor being one of gender information, age information, ethnicity information, and emotional information.

13. The method of claim 12, further comprising associating priority weights to each of the demographic factors.

14. The method of claim 13, wherein generation of the augmented set of information includes utilizing the priority weights to determine relative importance of each of the demographic factors.

15. The method of claim 14, wherein the advertisement is one of multiple advertisements, each advertisement being associated with a demographic target, wherein each demographic target is associated with a demographic factor.

16. The method of claim 15, wherein the second set of information comprises viewer metrics, at least one viewer metric being one of attention rate, demographic attention, emotional response, and location.

17. The method of claim 16, further comprising determining effectiveness of the first advertisement based on one or more viewer metrics.

18. The method of claim 11, further comprising determining effectiveness of the first advertisement based on one or more viewer metrics, wherein the second set of information comprises viewer metrics, at least one viewer metric being one of attention rate, demographic attention, emotional response, and location.

19. The method of claim 11, further comprising continuously monitoring the visual field to assess changing information associated with the one or more user.

20. A targeting advertisement system, the system comprising:
a display device for displaying advertisements directed to users within a visual field; and
an image capturing device for capturing images of users within the visual field,
wherein the system is configured to:
detect a user within the visual field and capture at least one image of the user;
determine a first set of information from the at least one image, the first set of information comprising demographic information associated with the user;
trigger the display device to display a first advertisement, the first advertisement being selected based on the first set of information; and
determine a second set of information while the first display is displaying the first advertisement,
wherein the second set of information is associated with effectiveness of the first advertisement.
